(19) United States
(12) Patent Application Publication
(10) Pub. No.: US 2026/0321906 A1
(43) Pub. Date: Oct. 15, 2026

(54) CAP PLATE ASSEMBLY, BATTERY ASSEMBLY, AND METHOD FOR MANUFACTURING THE SAME

(71) Applicant: SK On Co., Ltd., Seoul (KR)

(72) Inventors: Na Eun GIL, Daejeon (KR); Hyun Ji KIM, Daejeon (KR); Jae Hui PARK, Daejeon (KR); Mi Young YOON, Daejeon (KR); Jong Hyeok LEE, Daejeon (KR); Ji Soo HAN, Daejeon (KR)

(21) Appl. No.: 19/643,824

(22) Filed: Apr. 10, 2026

(30) Foreign Application Priority Data
Apr. 10, 2025 (KR) 10-2025-0046752
Mar. 11, 2026 (KR) 10-2026-0043462

(51) Int. Cl. H01M 50/528; H01M 10/04; H01M 50/103; H01M 50/148; H01M 50/169; H01M 50/172; H01M 50/188; H01M 50/533; H01M 50/536; H01M 50/54; H01M 50/566; H01M 50/586; H01M 50/593

(52) U.S. Cl. CPC H01M 50/528; H01M 10/049; H01M 50/103; H01M 50/154; H01M 50/169; H01M 50/172; H01M 50/188; H01M 50/533; H01M 50/536; H01M 50/54; H01M 50/566; H01M 50/586; H01M 50/593

(57) ABSTRACT

A cap plate assembly electrically connected to an electrode tab of at least one electrode assembly, the cap plate assembly may include: a foil connector including a plurality of ribs extending in a first direction and arranged side by side in a second direction intersecting the first direction; a cap plate including a plurality of grooves overlapping the plurality of ribs in a third direction intersecting the first direction and the second direction; and a weld portion electrically connecting the electrode tab, the plurality of ribs, and the plurality of grooves to each other.

### CROSS-REFERENCE TO RELATED PATENT APPLICATION

This disclosure claims priority under 35 U.S.C. § 119(a) to Korean patent application number 10-2025-0046752 filed on Apr. 10, 2025, and Korean patent application number 10-2026-0043462 filed on Mar. 11, 2026, in the Ministry of Intellectual Property, the entire disclosure of which is incorporated by reference herein.

### TECHNICAL FIELD

This disclosure relates to a cap plate assembly, a battery assembly, and a method for manufacturing the same.

### DISCUSSION OF THE RELATED ART

In general, in a process of welding a cap assembly and an uncoated portion (a portion where an active material is not applied) of an electrode during a manufacturing process of a secondary battery, welding between a cap plate and a copper rivet requires high precision. This is because the welding is to be performed in a circular shape at an accurate position, and even a slight misalignment of the position is likely to result in a defect.

The above description is merely provided to aid in understanding of a background art related to the technical ideas of this disclosure, and thus the above description is not to be construed as a prior art known to those skilled in the art of this disclosure.

### SUMMARY

According to an aspect of this disclosure, a cap plate assembly, a battery assembly, and a method for manufacturing the same with improved welding ease may be provided.

Meanwhile, this disclosure may be widely applied in fields of green technology such as electric vehicles, battery charging stations, energy storage systems (ESS), and photovoltaics and wind power utilizing batteries. In addition, this disclosure may be used in eco-friendly mobility including electric vehicles and hybrid vehicles for preventing climate change by suppressing air pollution and greenhouse gas emissions.

However, technical problems of this disclosure are not necessarily limited to those mentioned above, and other technical problems not mentioned herein will be clearly understood by those skilled in the art from the following description.

A cap plate assembly according to this disclosure is electrically connected to an electrode tab of at least one electrode assembly, and may include: a foil connector including a plurality of ribs extending in a first direction and arranged side by side in a second direction intersecting the first direction; a cap plate including a plurality of grooves overlapping the plurality of ribs in a third direction intersecting the first direction and the second direction; and a weld portion electrically connecting the electrode tab, the plurality of ribs, and the plurality of grooves to each other.

In an aspect, the foil connector may further include: an electrode bridge extending in the second direction and connecting one rib and another rib adjacent to each other among the plurality of ribs; and an electrode terminal extending from the electrode bridge in the third direction.

In an aspect, the cap plate assembly may further include a gasket disposed between the foil connector and the cap plate and surrounding at least a portion of the electrode terminal.

In an aspect, the cap plate may further include: a terminal hole through which the electrode terminal passes; and a terminal groove surrounding the terminal hole, wherein the cap plate assembly further comprises may further include: a second insulating plate disposed in the terminal groove; and a terminal plate disposed on the second insulating plate in the terminal groove.

In an aspect, the cap plate assembly may further include a third insulating plate coated on an upper surface of the cap plate excluding the plurality of grooves, a side surface of the cap plate, and an upper surface of the terminal plate.

In an aspect, the cap plate assembly may further include a first insulating plate disposed between the electrode tab and the foil connector and including a plurality of first holes overlapping the plurality of ribs in the third direction.

A battery assembly according to this disclosure may include: at least one electrode assembly including an electrode tab; a casing accommodating the at least one electrode assembly; and a cap plate assembly electrically connected to the electrode tab, and the cap plate assembly may include: a foil connector including a plurality of ribs extending in a first direction and arranged side by side in a second direction intersecting the first direction; a cap plate including a plurality of grooves overlapping the plurality of ribs in a third direction intersecting the first direction and the second direction; and a weld portion electrically connecting the electrode tab, the plurality of ribs, and the plurality of grooves to each other.

In an aspect, the electrode assembly may include: a first electrode assembly including a first electrode tab; and a second electrode assembly including a second electrode tab, the first electrode tab may include: a first-first electrode tab at least a portion of which extends in the second direction; and a first-second electrode tab at least a portion of which extends in a direction opposite to the second direction, and the second electrode tab may include: a second-first electrode tab at least a portion of which extends in the second direction; and a second-second electrode tab at least a portion of which extends in a direction opposite to the second direction.

In an aspect, the first-first electrode tab and the first-second electrode tab may be non-overlapping in the first direction, the second-first electrode tab and the second-second electrode tab may be non-overlapping in the first direction, and the first-first electrode tab and the second-second electrode tab may be overlapping in the first direction.

In an aspect, the weld portion may include: a first weld portion electrically connecting the first-second electrode tab, one of the plurality of ribs, and one of the plurality of grooves to each other; a second weld portion electrically connecting the first-first electrode tab, the second-second electrode tab, another one of the plurality of ribs, and another one of the plurality of grooves to each other; and a third weld portion electrically connecting the second-first electrode tab, yet another one of the plurality of ribs, and yet another one of the plurality of grooves to each other.

In an aspect, the cap plate assembly may further include a first insulating plate disposed between the electrode tab and the foil connector and including a plurality of first holes overlapping the plurality of ribs in the third direction.

In an aspect, the foil connector may further include: an electrode bridge extending in the second direction and connecting one rib and another rib adjacent to each other among the plurality of ribs; and an electrode terminal extending from the electrode bridge in the third direction.

In an aspect, the cap plate may further include: a terminal hole through which the electrode terminal passes; and a terminal groove surrounding the terminal hole, and the battery assembly may further include: a second insulating plate disposed in the terminal groove; and a terminal plate disposed on the second insulating plate in the terminal groove.

In an aspect, the cap plate assembly may further include a third insulating plate coated on an upper surface of the cap plate excluding the plurality of grooves, a side surface of the cap plate, and an upper surface of the terminal plate.

In an aspect, the third insulating plate may be disposed between the casing and the cap plate.

A method for manufacturing a battery assembly according to this disclosure may include: cutting a first electrode tab extending in a first direction of a first electrode assembly in a second direction intersecting the first direction to form a first-first electrode tab and a first-second electrode tab; cutting a second electrode tab extending in the first direction of a second electrode assembly in the second direction to form a second-first electrode tab and a second-second electrode tab; bending the first-first electrode tab and the second-first electrode tab in the second direction; bending the first-second electrode tab and the second-second electrode tab in a direction opposite to the second direction; accommodating the first electrode assembly and the second electrode assembly in a casing; contacting the other surface of a cap plate with the first-first electrode tab, the first-second electrode tab, the second-first electrode tab, and the second-second electrode tab such that a plurality of grooves formed on one surface of the cap plate face an outer side; and performing a primary welding of the first electrode tab and the second electrode tab to the cap plate by heating the plurality of grooves.

In an aspect, the primary welding may include irradiating a laser beam linearly onto the plurality of grooves.

In an aspect, the primary welding may include: forming a first weld portion electrically connecting one of the plurality of grooves, one rib overlapping the one groove in a third direction intersecting the first direction and the second direction, and the first-second electrode tab to each other; forming a second weld portion electrically connecting another one of the plurality of grooves, another rib overlapping the another groove in the third direction, the first-first electrode tab, and the second-second electrode tab to each other; and forming a third weld portion electrically connecting yet another one of the plurality of grooves, yet another rib overlapping the yet another groove in the third direction, and the second-first electrode tab to each other.

In an aspect, the method may further include performing a secondary welding of a contact surface where the casing and the cap plate abut each other, after the primary welding.

In an aspect, the secondary welding may include irradiating a laser beam linearly onto the contact surface.

According to an aspect of this disclosure, welding defects of a battery assembly may be reduced.

However, effects of this disclosure are not necessarily limited to those described above, and various extensions may be made without departing from the spirit and scope of this disclosure.

### BRIEF DESCRIPTION OF THE DRAWINGS

A more complete appreciation of this disclosure and many of the attendant aspects thereof will be readily obtained as the same becomes better understood by reference to the following detailed description when considered in connection with the accompanying drawings, wherein:

FIG. 1 is a perspective view schematically illustrating a cap plate assembly and a battery assembly according to an aspect.

FIG. 2 is a plan view schematically illustrating a partial configuration of the battery assembly shown in FIG. 1.

FIG. 3 is a plan view schematically illustrating a partial configuration of the cap plate assembly shown in FIG. 1.

FIG. 4 is a plan view schematically illustrating a partial configuration of the cap plate assembly shown in FIG. 1.

FIG. 5 is a plan view schematically illustrating a partial configuration of the cap plate assembly shown in FIG. 1.

FIG. 6 is a front view schematically illustrating a partial configuration of the cap plate assembly shown in FIG. 1.

FIG. 7 is a front view schematically illustrating a partial configuration of the battery assembly shown in FIG. 1.

FIG. 8 is a cross-sectional view schematically illustrating a cross-section taken along line A-A′ of FIG. 7.

FIG. 9 is a cross-sectional view schematically illustrating a cross-section taken along line B-B′ of FIG. 7.

FIG. 10 is a flowchart schematically illustrating a method for manufacturing a battery assembly according to an aspect.

FIG. 11 is a perspective view schematically illustrating some steps of FIG. 10.

FIG. 12 is a perspective view schematically illustrating some steps of FIG. 10.

### DETAILED DESCRIPTION

Hereinafter, this disclosure will be described in detail with reference to the accompanying drawings. However, this disclosure is merely exemplary and is not necessarily limited to the specific aspects described as examples.

Terms used throughout the specification of this disclosure are for the purpose of describing aspects and are not intended to necessarily limit this disclosure. For example, a singular expression may include a plural expression unless the context clearly indicates otherwise. In addition, when a certain part “includes” a certain component, this does not exclude other components but may further include other components, unless otherwise specified. “At least one of X, Y, or Z” and “at least one selected from a group consisting of X, Y, and Z” may be interpreted as one of X, one of Y, one of Z, or any combination of two or more of X, Y, and Z (e.g., XY, YZ, ZX, XYZ). Herein, “and/or” includes all combinations of one or more of the corresponding configurations.

When a certain part is described as being “connected” to another part, this may include not only a case of being “directly connected” but also a case of being “indirectly connected” with another component interposed therebetween.

Terms such as first, second, and the like may be used to describe various components. When one component performs the same function but is disposed at a plurality of different locations, the terms are used to distinguish one component from another component. Therefore, a first component may also refer to a second component without departing from the scope disclosed herein.

Hereinafter, various aspects will be described with reference to schematic drawings. Accordingly, it is expected that shapes thereof may vary according to manufacturing tolerances and/or applied technologies. Therefore, the aspects of this disclosure are not to be construed as being necessarily limited to specific shapes or sizes illustrated for convenience of description. As such, the shapes illustrated in the drawings may not represent the actual shapes of areas of a device, and the aspects of this disclosure are not to be necessarily limited thereto.

When an aspect is otherwise implementable, a specific process order may be performed differently from the described order. For example, two processes described in succession may be performed substantially simultaneously, or may be performed in an order reverse to the described order.

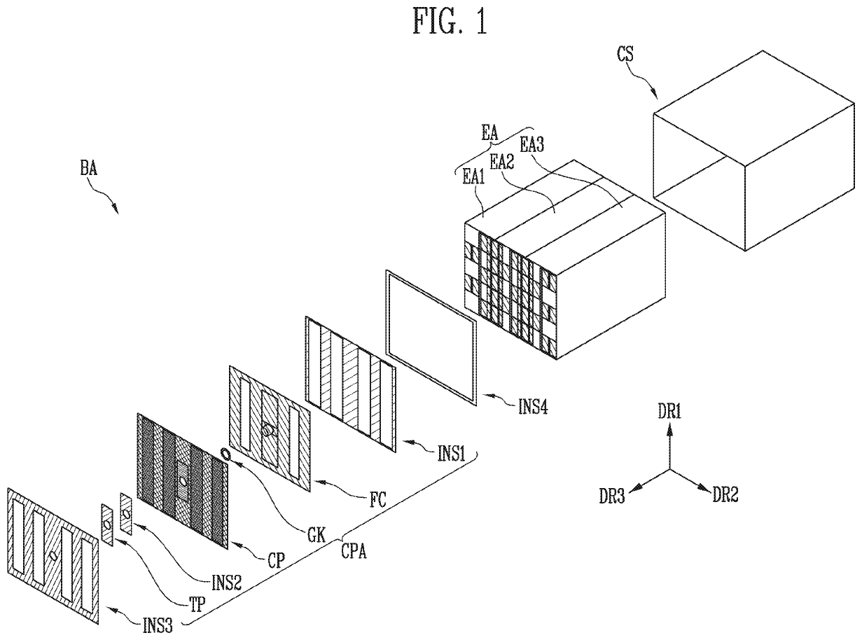

Hereinafter, a cap plate assembly CPA and a battery assembly BA will be described with reference to FIGS. 1 to 9.

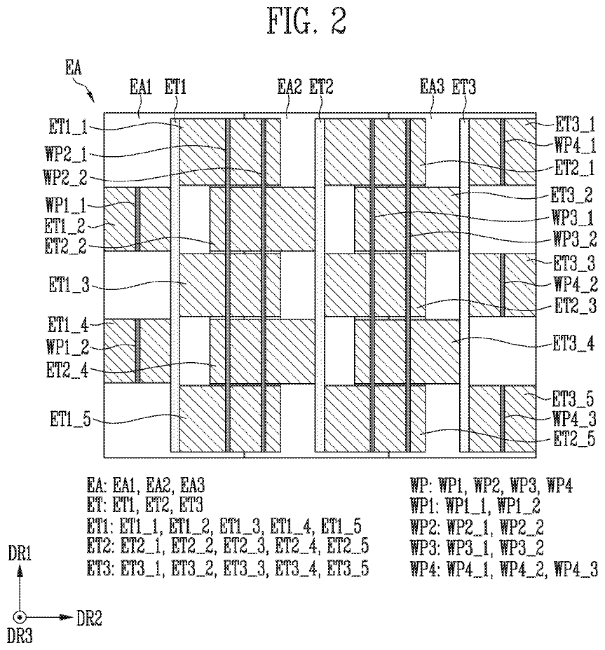

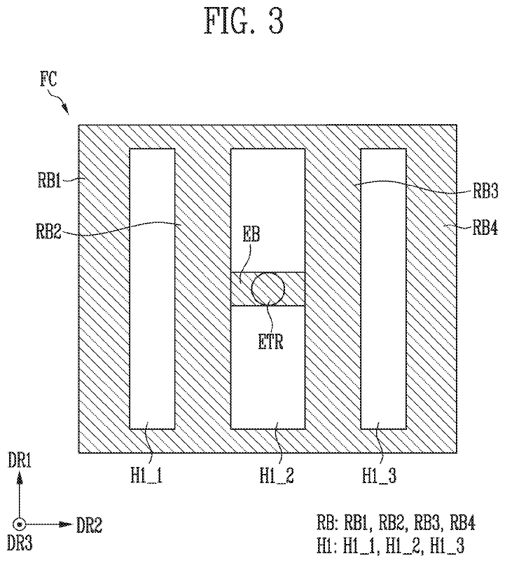

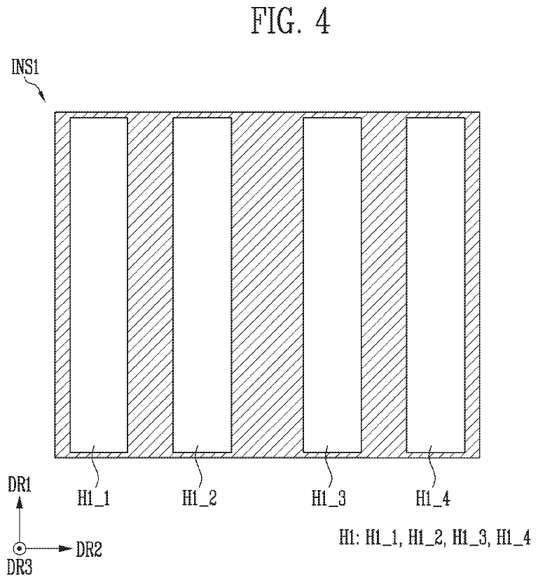

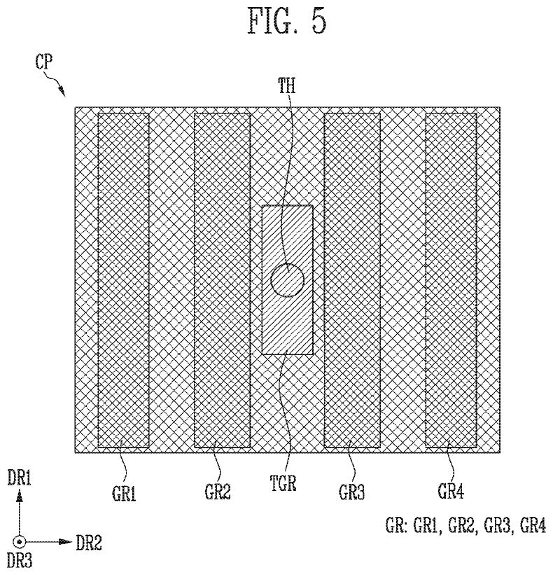

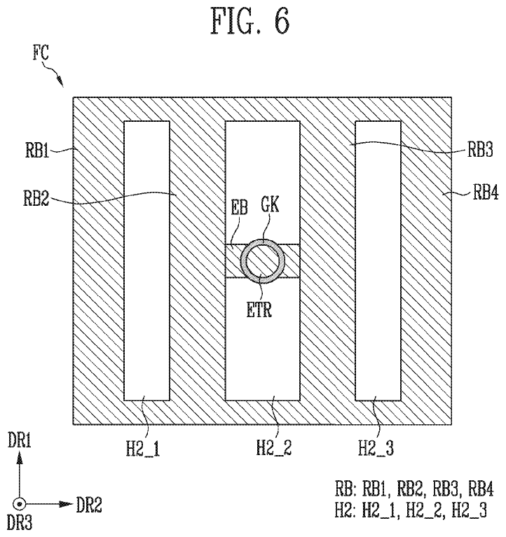

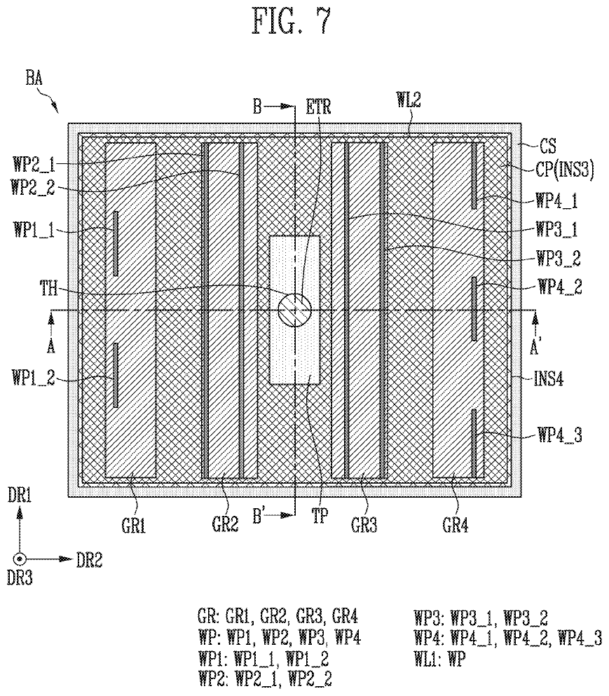

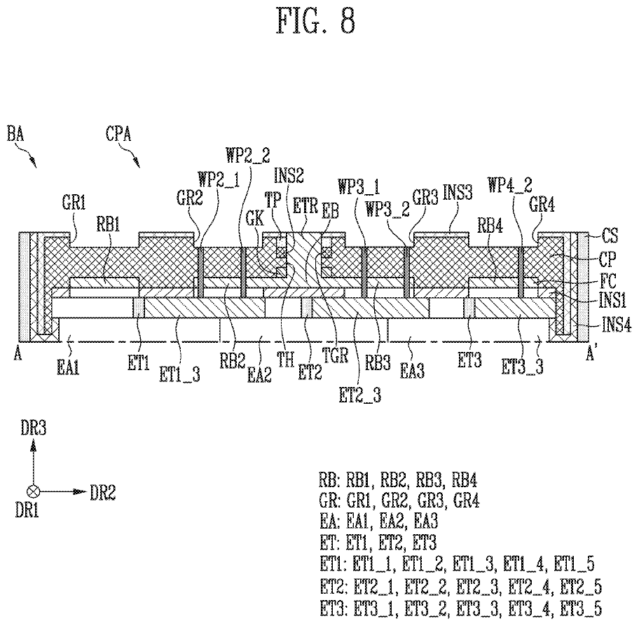

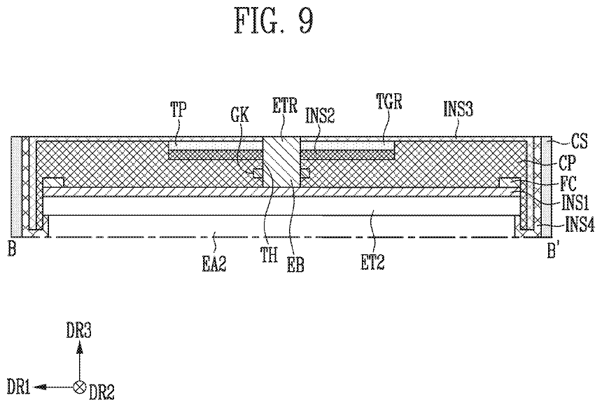

FIG. 1 is a perspective view schematically illustrating a cap plate assembly and a battery assembly according to an aspect. FIG. 2 is a plan view schematically illustrating a partial configuration of the battery assembly shown in FIG. 1. FIG. 3 is a plan view schematically illustrating a partial configuration of the cap plate assembly shown in FIG. 1. FIG. 4 is a plan view schematically illustrating a partial configuration of the cap plate assembly shown in FIG. 1. FIG. 5 is a plan view schematically illustrating a partial configuration of the cap plate assembly shown in FIG. 1. FIG. 6 is a front view schematically illustrating a partial configuration of the cap plate assembly shown in FIG. 1. FIG. 7 is a front view schematically illustrating a partial configuration of the battery assembly shown in FIG. 1. FIG. 8 is a cross-sectional view schematically illustrating a cross-section taken along line A-A′ of FIG. 7. FIG. 9 is a cross-sectional view schematically illustrating a cross-section taken along line B-B′ of FIG. 7.

Referring to FIGS. 1 and 2 together, a cap plate assembly CPA according to an aspect of this disclosure may include a foil connector FC, a first insulating plate INS1, a gasket GK, a cap plate CP, a second insulating plate INS2, a terminal plate TP, and a weld portion WP. The cap plate assembly CPA may be configured to be electrically connected to an electrode tab ET of at least one electrode assembly EA.

The electrode assembly EA may include a first electrode assembly EA1, a second electrode assembly EA2, and a third electrode assembly EA3.

The first electrode assembly EA1 may include a first electrode tab ET1 extending in a first direction DR1. The second electrode assembly EA2 may include a second electrode tab ET2 extending in the first direction DR1. The third electrode assembly EA3 may include a third electrode tab ET3 extending in the first direction DR1.

The first electrode tab ET1 may include a first-first electrode tab ET1_1, a first-third electrode tab ET1_3, and a first-fifth electrode tab ET1_5, at least a portion of each of which extends in a second direction DR2 intersecting the first direction DR1. In addition, the first electrode tab ET1 may include a first-second electrode tab ET1_2 and a first-fourth electrode tab ET1_4, at least a portion of each of which extends in a direction opposite to the second direction DR2. The first-first electrode tab ET1_1, the first-second electrode tab ET1_2, the first-third electrode tab ET1_3, the first-fourth electrode tab ET1_4, and the first-fifth electrode tab ET1_5 may alternately extend in the second direction DR2 or in a direction opposite to the second direction DR2 along a direction opposite to the first direction DR1. For example, the first-first electrode tab ET1_1 and the first-second electrode tab ET1_2 may be non-overlapping in the first direction DR1.

The second electrode tab ET2, similarly to the first electrode tab ET1, may include a second-first electrode tab ET2_1, a second-third electrode tab ET2_3, and a second-fifth electrode tab ET2_5, at least a portion of each of which extends in the second direction DR2 intersecting the first direction DR1. In addition, the second electrode tab ET2 may include a second-second electrode tab ET2_2 and a second-fourth electrode tab ET2_4, at least a portion of each of which extends in a direction opposite to the second direction DR2. The second-first electrode tab ET2_1, the second-second electrode tab ET2_2, the second-third electrode tab ET2_3, the second-fourth electrode tab ET2_4, and the second-fifth electrode tab ET2_5 may alternately extend in the second direction DR2 or in a direction opposite to the second direction DR2 along a direction opposite to the first direction DR1. For example, the second-first electrode tab ET2_1 and the second-second electrode tab ET2_2 may be non-overlapping in the first direction DR1.

The third electrode tab ET3, similarly to the first electrode tab ET1 and the second electrode tab ET2, may include a third-first electrode tab ET3_1, a third-third electrode tab ET3_3, and a third-fifth electrode tab ET3_5, at least a portion of each of which extends in the second direction DR2 intersecting the first direction DR1. In addition, the third electrode tab ET3 may include a third-second electrode tab ET3_2 and a third-fourth electrode tab ET3_4, at least a portion of each of which extends in a direction opposite to the second direction DR2. The third-first electrode tab ET3_1, the third-second electrode tab ET3_2, the third-third electrode tab ET3_3, the third-fourth electrode tab ET3_4, and the third-fifth electrode tab ET3_5 may alternately extend in the second direction DR2 or in a direction opposite to the second direction DR2 along a direction opposite to the first direction DR1. For example, the third-first electrode tab ET3_1 and the third-second electrode tab ET3_2 may be non-overlapping in the first direction DR1.

According to such a structure, one first electrode tab ET1 and one second electrode tab ET2 may overlap in the first direction DR1. In addition, one second electrode tab ET2 and one third electrode tab ET3 may overlap in the first direction DR1. In addition, one third electrode tab ET3 and one fourth electrode tab ET4 may overlap in the first direction DR1. For example, the first-first electrode tab ET1_1 and the second-second electrode tab ET2_2 may overlap in the first direction DR1.

Referring to FIGS. 1 and 3 together, the foil connector FC may include a plurality of ribs RB extending in the first direction DR1 and arranged side by side in the second direction DR2 intersecting the first direction DR1.

The plurality of ribs RB may include a first rib RB1, a second rib RB2, a third rib RB3, and a fourth rib RB4. The first rib RB1, the second rib RB2, the third rib RB3, and the fourth rib RB4 may be arranged side by side along the second direction DR2.

A plurality of first holes H1 may be disposed between the plurality of ribs RB. For example, the plurality of first holes H1 may include a first-first hole H1_1, a first-second hole H1_2, and a first-third hole H1_3. The first-first hole H1_1 may be disposed between the first rib RB1 and the second rib RB2. The first-second hole H1_2 may be disposed between the second rib RB2 and the third rib RB3. The first-third hole H1_3 may be disposed between the third rib RB3 and the fourth rib RB4.

In addition, the foil connector FC may further include: an electrode bridge EB extending in the second direction DR2 and connecting one rib (RB2 in FIG. 2) and another rib (RB3 in FIG. 2) adjacent to each other among the plurality of ribs RB; and an electrode terminal ETR extending from the electrode bridge EB in the third direction DR3.

The foil connector FC may be composed of aluminum when the electrode tab ET that is electrically connected thereto is a positive electrode, and may be composed of nickel when the electrode tab ET is a negative electrode. In other words, the plurality of ribs RB, the electrode bridge EB, and the electrode terminal ETR may all be composed of aluminum or nickel.

Referring to FIGS. 1 and 4 together, the first insulating plate INS1 may be disposed between the electrode tab ET of the electrode assembly EA and the foil connector FC, and may include a plurality of first holes H1 overlapping the plurality of ribs RB in the third direction DR3.

The plurality of first holes H1 may include a first-first hole H1_1, a first-second hole H1_2, a first-third hole H1_3, and a first-fourth hole H1_4. The first-first hole H1_1 may overlap the first rib RB1 in the third direction DR3. The first-second hole H1_2 may overlap the second rib RB2 in the third direction DR3. The first-third hole H1_3 may overlap the third rib RB3 in the third direction DR3. The first-fourth hole H1_4 may overlap the fourth rib RB4 in the third direction DR3.

The first insulating plate INS1 may include a polymer material having electrical insulation properties, heat resistance, and durability. For example, the first insulating plate INS1 may include a synthetic resin such as one or a combination of polypropylene (PP), polyethylene (PE), polycarbonate (PC), and polyimide (PI) in consideration of chemical and thermal stability and mechanical strength with respect to an electrolyte filled in the electrode assembly EA. Alternatively, the first insulating plate INS1 may include an insulating material such as alumina (Al₂O₃), zirconia (ZrO₂), or a ceramic composite.

As such, the first insulating plate INS1 may spatially space the electrode tab ET and the foil connector FC apart from each other so as to prevent direct contact therebetween, thereby electrically insulating the electrode tab ET and the foil connector FC from each other.

Referring to FIGS. 1 and 5 together, the cap plate CP may include a plurality of grooves GR overlapping the plurality of ribs RB of the foil connector FC in a third direction DR3 intersecting the first direction DR1 and the second direction DR2. The plurality of grooves GR may have a thinner thickness compared to a maximum thickness of the cap plate CP. For example, the plurality of grooves GR may be a step in which a partial area is recessed in a direction from one surface of the cap plate CP toward the other surface thereof.

The plurality of grooves GR may include a first groove GR1, a second groove GR2, a third groove GR3, and a fourth groove GR4. The first groove GR1, the second groove GR2, the third groove GR3, and the fourth groove GR4 may be arranged side by side along the second direction DR2.

The first groove GR1 may overlap the first rib RB1 in the third direction DR3. The second groove GR2 may overlap the second rib RB2 in the third direction DR3. The third groove GR3 may overlap the third rib RB3 in the third direction DR3. The fourth groove GR4 may overlap the fourth rib RB4 in the third direction DR3.

In addition, the cap plate CP may further include a terminal hole TH through which the electrode terminal ETR of the foil connector FC passes, and a terminal groove TGR surrounding the terminal hole TH. The terminal groove TGR, similarly to the plurality of grooves GR, may have a thinner thickness compared to the maximum thickness of the cap plate CP. In other words, the terminal groove TGR may be a step in which a partial area is recessed in a direction from one surface of the cap plate CP toward the other surface thereof.

The second insulating plate INS2 may be disposed in the terminal groove TGR. The terminal plate TP may be disposed on the second insulating plate INS2 in the terminal groove TGR. In other words, the second insulating plate INS2 and the terminal plate TP may be sequentially disposed in the third direction DR3 within the terminal groove TGR.

The second insulating plate INS2, similarly to the first insulating plate INS1, may include a polymer material having electrical insulation properties, heat resistance, and durability. For example, the second insulating plate INS2 may include a synthetic resin such as one or a combination of polypropylene (PP), polyethylene (PE), polycarbonate (PC), and polyimide (PI) in consideration of chemical and thermal stability and mechanical strength with respect to an electrolyte filled in the electrode assembly EA. Alternatively, the second insulating plate INS2 may include an insulating material such as alumina (Al₂O₃), zirconia (ZrO₂), or a ceramic composite.

As such, the second insulating plate INS2 may cover a lower surface of the terminal plate TP, thereby reducing a contact area between the terminal plate TP and the cap plate CP. Through this, unnecessary current leakage may be prevented to prevent overheating and to improve electrical stability.

Referring to FIG. 6 together with FIGS. 1, 8, and 9, the gasket GK may be disposed between the foil connector FC and the cap plate CP, and may surround at least a portion of the electrode terminal ETR.

The gasket GK may be composed of a material having a predetermined elasticity. Through this, the gasket GK may seal between the foil connector FC and the cap plate CP so that the electrolyte of the electrode assembly EA does not leak to the outside.

Referring to FIG. 8 together with FIGS. 1, 2, and 7, the weld portion WP may electrically connect the electrode tab ET, the plurality of ribs RB, and the plurality of grooves GR to each other.

The weld portion WP may include a first weld portion WP1, a second weld portion WP2, a third weld portion WP3, and a fourth weld portion WP4.

The first weld portion WP1 may include a first-first weld portion WP1_1 overlapping the first-second electrode tab ET1_2, the first rib RB1, and the first groove GR1 in the third direction DR3; and a first-second weld portion WP1_2 overlapping the first-fourth electrode tab ET1_4, the first rib RB1, and the first groove GR1 in the third direction DR3. In other words, the first-first weld portion WP1_1 may electrically connect the first-second electrode tab ET1_2, the first rib RB1, and the first groove GR1 to each other. In addition, the first-second weld portion WP1_2 may electrically connect the first-fourth electrode tab ET1_4, the first rib RB1, and the first groove GR1 to each other. The first-first weld portion WP1_1 and the first-second weld portion WP1_2 may be spaced apart from each other in the first direction DR1.

The second weld portion WP2 may include a second-first weld portion WP2_1 and a second-second weld portion WP2_2 overlapping the first-first electrode tab ET1_1, the second-second electrode tab ET2_2, the first-third electrode tab ET1_3, the second-fourth electrode tab ET2_4, and the first-fifth electrode tab ET1_5, and the second rib RB2 and the second groove GR2 in the third direction DR3. In other words, the second-first weld portion WP2_1 and the second-second weld portion WP2_2 may electrically connect the first-first electrode tab ET1_1, the second-second electrode tab ET2_2, the first-third electrode tab ET1_3, the second-fourth electrode tab ET2_4, and the first-fifth electrode tab ET1_5, and the second rib RB2 and the second groove GR2 to each other. The second-first weld portion WP2_1 and the second-second weld portion WP2_2 may be spaced apart from each other in the second direction DR2.

The third weld portion WP3 may include a third-first weld portion WP3_1 and a third-second weld portion WP3_2 overlapping the second-first electrode tab ET2_1, the third-second electrode tab ET3_2, the second-third electrode tab ET2_3, the third-fourth electrode tab ET3_4, and the second-fifth electrode tab ET2_5, and the third rib RB3 and the third groove GR3 in the third direction DR3. In other words, the third-first weld portion WP3_1 and the third-second weld portion WP3_2 may electrically connect the second-first electrode tab ET2_1, the third-second electrode tab ET3_2, the second-third electrode tab ET2_3, the third-fourth electrode tab ET3_4, and the second-fifth electrode tab ET2_5, and the third rib RB3 and the third groove GR3 to each other. The third-first weld portion WP3_1 and the third-second weld portion WP3_2 may be spaced apart from each other in the second direction DR2.

The fourth weld portion WP4 may include a fourth-first weld portion WP4_1 overlapping the third-first electrode tab ET3_1, the fourth rib RB4, and the fourth groove GR4 in the third direction DR3, a fourth-second weld portion WP4_2 overlapping the third-third electrode tab ET3_3, the fourth rib RB4, and the fourth groove GR4 in the third direction DR3, and a fourth-third weld portion WP4_3 overlapping the third-fifth electrode tab ET3_5, the fourth rib RB4, and the fourth groove GR4 in the third direction DR3. In other words, the fourth-first weld portion WP4_1 may electrically connect the third-first electrode tab ET3_1, the fourth rib RB4, and the fourth groove GR4 to each other. In addition, the fourth-second weld portion WP4_2 may electrically connect the third-third electrode tab ET3_3, the fourth rib RB4, and the fourth groove GR4 to each other. In addition, the fourth-third weld portion WP4_3 may electrically connect the third-fifth electrode tab ET3_5, the fourth rib RB4, and the fourth groove GR4 to each other. The fourth-first weld portion WP4_1, the fourth-second weld portion WP4_2, and the fourth-third weld portion WP4_3 may be spaced apart from each other in the first direction DR1.

For example, referring to FIG. 8, the second-first weld portion WP2_1 and the second-second weld portion WP2_2 may electrically connect the first-third electrode tab ET1_3, the second rib RB2, and the second groove GR2. In addition, the third-first weld portion WP3_1 and the third-second weld portion WP3_2 may electrically connect the second-third electrode tab ET2_3, the third rib RB3, and the third groove GR3. The fourth-second weld portion WP4_2 may electrically connect the third-third electrode tab ET3_3, the fourth rib RB4, and the fourth groove GR4.

Referring to FIG. 8, the cap plate assembly CPA according to this disclosure may further include a third insulating plate INS3 coated on an upper surface of the cap plate CP excluding the plurality of grooves GR, a side surface of the cap plate CP, and an upper surface of the terminal plate TP.

Although FIG. 8 depicts that the third insulating plate INS3 is disposed on the upper surface of the cap plate CP excluding the plurality of grooves GR, this disclosure is not necessarily limited thereto. For example, the third insulating plate INS3 may be coated on the entire upper surface of the cap plate CP including the plurality of grooves GR. However, for convenience of description, the following description will be focused on the third insulating plate INS3 being disposed on the upper surface of the cap plate CP excluding the plurality of grooves GR.

The third insulating plate INS3 may be disposed between the casing CS and the cap plate CP to electrically insulate the casing CS and the cap plate CP from each other.

The third insulating plate INS3, similarly to the first insulating plate INS1 and the second insulating plate INS2, may include a polymer material having electrical insulation properties, heat resistance, and durability. For example, the third insulating plate INS3 may include a synthetic resin such as one or a combination of polypropylene (PP), polyethylene (PE), polycarbonate (PC), and polyimide (PI) in consideration of chemical and thermal stability and mechanical strength with respect to an electrolyte filled in the electrode assembly EA. Alternatively, the third insulating plate INS3 may include an insulating material such as alumina (Al₂O₃), zirconia (ZrO₂), or a ceramic composite.

In the case of the cap plate assembly CPA according to this disclosure, the weld portion WP may be formed by irradiating a laser beam onto the groove GR of the cap plate CP having a relatively thin thickness. In other words, the weld portion WP may be formed by heating the groove GR of the cap plate CP with a laser beam, so that the rib RB of the foil connector FC and a portion of the electrode tab ET of the electrode assembly EA overlapping the groove GR in the third direction DR3 are melt-bonded.

As can be seen from FIG. 7, the weld portion WP has a linear shape and thus may be formed more easily and simply compared to welding in a curved or circular shape. Through this, a defect rate may be reduced in a process of performing welding to electrically connect the cap plate CP, the foil connector FC, and the electrode assembly EA.

Referring to FIGS. 7 to 9 together with FIG. 1, a battery assembly BA according to an aspect of this disclosure may include an electrode assembly EA, a casing CS, a cap plate assembly CPA, and a fourth insulating plate INS4.

Since the electrode assembly EA has substantially the same configuration as the electrode assembly EA described with reference to FIGS. 1 and 2, the foregoing description is incorporated herein, and a detailed description thereof will be omitted hereinafter.

The casing CS may accommodate at least one electrode assembly EA. The casing CS may include an empty space capable of accommodating at least one electrode assembly EA and an electrolyte therein. One side of the casing CS may be open, and the cap plate assembly CPA described above may be disposed in the casing CS through the open side.

Since the cap plate assembly CPA also has substantially the same configuration as the cap plate assembly CPA described with reference to FIGS. 1 to 6, the foregoing description is incorporated herein, and a detailed description thereof will be omitted hereinafter.

The fourth insulating plate INS4 may be disposed between each of the cap plate CP, the electrode tab ET, and the third insulating plate INS3 and the casing CS, to electrically insulate each of the cap plate CP, the electrode tab ET, and the third insulating plate INS3 from the casing CS.

The fourth insulating plate INS4, similarly to the first insulating plate INS1, the second insulating plate INS2, and the third insulating plate INS3, may include a polymer material having electrical insulation properties, heat resistance, and durability. For example, the fourth insulating plate INS4 may include a synthetic resin such as one or a combination of polypropylene (PP), polyethylene (PE), polycarbonate (PC), and polyimide (PI) in consideration of chemical and thermal stability and mechanical strength with respect to an electrolyte filled in the electrode assembly EA. Alternatively, the fourth insulating plate INS4 may include an insulating material such as alumina (Al₂O₃), zirconia (ZrO₂), or a ceramic composite.

The cap plate assembly CPA on which the third insulating plate INS3 is coated may be disposed inside the casing CS in which the fourth insulating plate INS4 is disposed on an inner surface. In this state, by applying a predetermined force in a direction from an outside of the casing CS toward a center thereof in the second direction DR2, the casing CS, the fourth insulating plate INS4, the third insulating plate INS3, and the cap plate CP may be more closely adhered to each other.

Accordingly, movement of the cap plate assembly CPA in the third direction DR3 may be restricted by friction between the casing CS, the fourth insulating plate INS4, the third insulating plate INS3, and the cap plate CP. In other words, the cap plate assembly CPA may not be separated from the casing CS by friction between the casing CS, the fourth insulating plate INS4, the third insulating plate INS3, and the cap plate CP.

In the case of the battery assembly BA according to this disclosure, the weld portion WP may be formed by irradiating a laser beam onto the groove GR of the cap plate CP having a relatively thin thickness. In other words, the weld portion WP may be formed by heating the groove GR of the cap plate CP with a laser beam, so that the rib RB of the foil connector FC and a portion of the electrode tab ET of the electrode assembly EA overlapping the groove GR in the third direction DR3 are melt-bonded. As illustrated in FIG. 7, the weld portion WP has a linear shape and thus may be formed more easily and simply compared to welding in a curved or circular shape. Through this, a defect rate may be reduced in a process of performing welding to electrically connect the cap plate CP, the foil connector FC, and the electrode assembly EA.

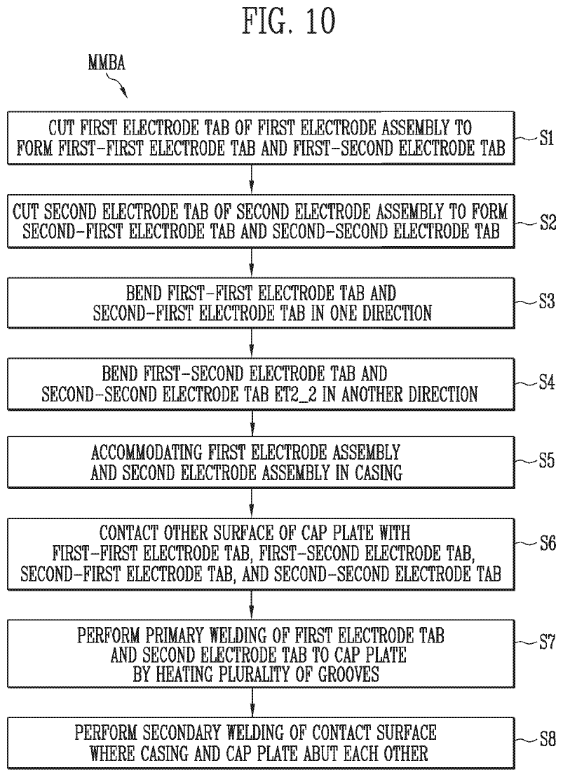

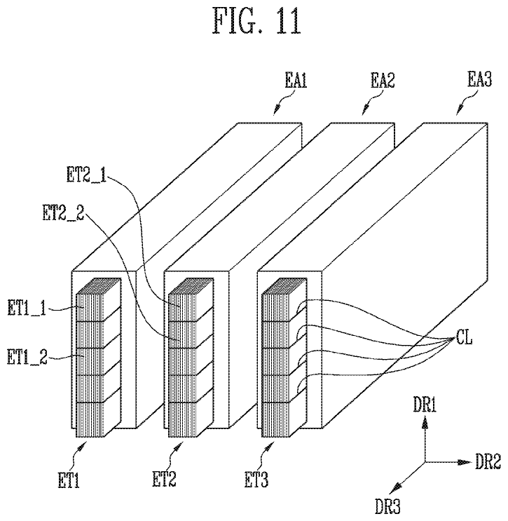

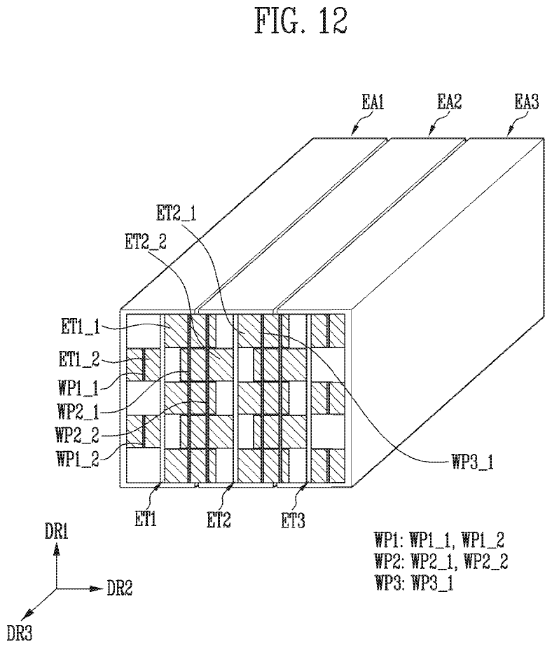

FIG. 10 is a flowchart schematically illustrating a method for manufacturing a battery assembly according to an aspect. FIG. 11 is a perspective view schematically illustrating some steps of FIG. 10. FIG. 12 is a perspective view schematically illustrating some steps of FIG. 10.

Referring to FIGS. 10 to 12 together, a method for manufacturing a battery assembly MMBA according to an aspect of this disclosure may include: cutting the first electrode tab ET1 extending in the first direction DR1 of the first electrode assembly EA1 in the second direction DR2 intersecting the first direction DR1 to form the first-first electrode tab ET1_1 and the first-second electrode tab ET1_2 (S1) (see FIG. 11); cutting the second electrode tab ET2 extending in the first direction DR1 of the second electrode assembly EA2 in the second direction DR2 to form the second-first electrode tab ET2_1 and the second-second electrode tab ET2_2 (S2) (see FIG. 11); bending the first-first electrode tab ET1_1 and the second-first electrode tab ET2_1 in the second direction DR2 (S3) (see FIG. 12); bending the first-second electrode tab ET1_2 and the second-second electrode tab ET2_2 in a direction opposite to the second direction DR2 (S4) (see FIG. 12); accommodating the first electrode assembly EA1 and the second electrode assembly EA2 in the casing CS (S5) (see FIG. 12); contacting the other surface of the cap plate CP with the first-first electrode tab ET1_1, the first-second electrode tab ET1_2, the second-first electrode tab ET2_1, and the second-second electrode tab ET2_2 such that the plurality of grooves GR formed on one surface of the cap plate CP face an outer side (S6) (see FIG. 12); and performing a primary welding of the first electrode tab ET1 and the second electrode tab ET2 to the cap plate CP by heating the plurality of grooves GR (S7) (see FIG. 12).

In the case of steps S1 and S2, the first electrode tab ET1 and the second electrode tab ET2 may each be cut into a plurality of pieces along a cutting line CL indicated in FIG. 11. For example, as illustrated in FIGS. 2 and 12, each of the first electrode tab ET1, the second electrode tab ET2, and the third electrode tab ET3 may be cut into five pieces.

In step S7, a laser beam may be linearly irradiated onto the plurality of grooves GR.

Referring again to FIGS. 2 and 7 together, step S7 may include forming the first weld portion WP1, forming the second weld portion WP2, forming the third weld portion WP3, and forming the fourth weld portion WP4.

Forming the first weld portion WP1 may include linearly irradiating a laser beam along a first welding line WL1, thereby electrically connecting the first groove GR1, the first rib RB1 overlapping the first groove GR1 in the third direction DR3, and each of the first-second electrode tab ET1_2 and the first-fourth electrode tab ET1_4 to each other.

Forming the second weld portion WP2 may include linearly irradiating a laser beam along the first welding line WL1, thereby electrically connecting the second groove GR2, the second rib RB2 overlapping the second groove GR2 in the third direction DR3, and the first-first electrode tab ET1_1, the second-second electrode tab ET2_2, the first-third electrode tab ET1_3, the second-fourth electrode tab ET2_4, and the first-fifth electrode tab ET1_5 to each other.

Forming the third weld portion WP3 may include linearly irradiating a laser beam along the first welding line WL1, thereby electrically connecting the third groove GR3, the third rib RB3 overlapping the third groove GR3 in the third direction DR3, and the second-first electrode tab ET2_1, the third-second electrode tab ET3_2, the second-third electrode tab ET2_3, the third-fourth electrode tab ET3_4, and the second-fifth electrode tab ET2_5 to each other.

Forming the fourth weld portion WP4 may include linearly irradiating a laser beam along the first welding line WL1, thereby electrically connecting the fourth groove GR4, the fourth rib RB4 overlapping the fourth groove GR4 in the third direction DR3, and each of the third-first electrode tab ET3_1, the third-third electrode tab ET3_3, and the third-fifth electrode tab ET3_5 to each other.

Referring again to FIG. 10 together with FIG. 7, the method may further include performing a secondary welding of a contact surface where the casing CS and the cap plate CP abut each other (S8) after step S7.

Step S8 may include linearly irradiating a laser beam along a second welding line WL2 corresponding to the contact surface between the casing CS and the cap plate CP. For example, when viewed in the third direction DR3, the contact surface between the casing CS and the cap plate CP has a rectangular shape, and thus a laser beam may be irradiated along the second welding line WL2 having a rectangular shape to bond the casing CS and the cap plate CP.

In aspects, since both the primary welding (step S7) and the secondary welding (step S8) may be performed by linearly irradiating a laser beam, the welding may be performed easily and simply without precise control such as curved or circular driving. Through this, a defect rate may be reduced in a process of performing welding to electrically connect the cap plate CP, the foil connector FC, and the electrode assembly EA.

As described above, movement of the cap plate assembly CPA in the third direction DR3 may be restricted by friction between the casing CS, the fourth insulating plate INS4, the third insulating plate INS3, and the cap plate CP. In other words, the cap plate assembly CPA may not be separated from the casing CS by friction between the casing CS, the fourth insulating plate INS4, the third insulating plate INS3, and the cap plate CP. In addition, in a case where the casing CS and the cap plate assembly CPA are secondarily welded to further improve a bonding strength between the casing CS and the cap plate assembly CPA, a defect rate may also be reduced.

This disclosure may be implemented in various modified forms, and the scope of rights is not necessarily limited to the above-described aspects. Therefore, if a modified aspect includes the components of the claims of this disclosure, such a modified aspect is to be considered as belonging to the scope of rights of this disclosure.

What is claimed is:

1. A cap plate assembly configured to be electrically connected to an electrode tab of at least one electrode assembly, the cap plate assembly comprising:
a foil connector including a plurality of ribs extending in a first direction and arranged side by side in a second direction intersecting the first direction;
a cap plate including a plurality of grooves overlapping the plurality of ribs in a third direction intersecting the first direction and the second direction; and
a weld portion configured to electrically connect the electrode tab, the plurality of ribs, and the plurality of grooves to each other.

2. The cap plate assembly of claim 1, wherein the foil connector further comprises:
an electrode bridge extending in the second direction and connecting one rib and another rib adjacent to each other among the plurality of ribs; and
an electrode terminal extending from the electrode bridge in the third direction.

3. The cap plate assembly of claim 2, further comprising a gasket disposed between the foil connector and the cap plate and surrounding at least a portion of the electrode terminal.

4. The cap plate assembly of claim 2, wherein the cap plate further comprises:
a terminal hole through which the electrode terminal passes; and
a terminal groove surrounding the terminal hole, and
wherein the cap plate assembly further comprises:
a second insulating plate disposed in the terminal groove; and
a terminal plate disposed on the second insulating plate in the terminal groove.

5. The cap plate assembly of claim 4, further comprising a third insulating plate configured to be coated on an upper surface of the cap plate excluding the plurality of grooves, a side surface of the cap plate, and an upper surface of the terminal plate.

6. The cap plate assembly of claim 1, further comprising a first insulating plate disposed between the electrode tab and the foil connector and including a plurality of first holes overlapping the plurality of ribs in the third direction.

7. A battery assembly comprising:
at least one electrode assembly including an electrode tab;
a casing configured to accommodate the at least one electrode assembly; and
a cap plate assembly configured to be electrically connected to the electrode tab,
wherein the cap plate assembly comprises:
a foil connector including a plurality of ribs extending in a first direction and arranged side by side in a second direction intersecting the first direction;
a cap plate including a plurality of grooves overlapping the plurality of ribs in a third direction intersecting the first direction and the second direction; and
a weld portion configured to electrically connect the electrode tab, the plurality of ribs, and the plurality of grooves to each other.

8. The battery assembly of claim 7, wherein the electrode assembly comprises:
a first electrode assembly including a first electrode tab; and
a second electrode assembly including a second electrode tab,
wherein the first electrode tab comprises:
a first-first electrode tab at least a portion of which extends in the second direction; and
a first-second electrode tab at least a portion of which extends in a direction opposite to the second direction, and
wherein the second electrode tab comprises:
a second-first electrode tab at least a portion of which extends in the second direction; and
a second-second electrode tab at least a portion of which extends in a direction opposite to the second direction.

9. The battery assembly of claim 8, wherein:
the first-first electrode tab and the first-second electrode tab are non-overlapping in the first direction,
the second-first electrode tab and the second-second electrode tab are non-overlapping in the first direction, and
the first-first electrode tab and the second-second electrode tab are overlapping in the first direction.

10. The battery assembly of claim 9, wherein the weld portion comprises:
a first weld portion configured to electrically connect the first-second electrode tab, one of the plurality of ribs, and one of the plurality of grooves to each other;
a second weld portion configured to electrically connect the first-first electrode tab, the second-second electrode tab, another one of the plurality of ribs, and another one of the plurality of grooves to each other; and
a third weld portion configured to electrically connect the second-first electrode tab, yet another one of the plurality of ribs, and yet another one of the plurality of grooves to each other.

11. The battery assembly of claim 7, wherein the cap plate assembly further comprises a first insulating plate disposed between the electrode tab and the foil connector and including a plurality of first holes overlapping the plurality of ribs in the third direction.

12. The battery assembly of claim 7, wherein the foil connector further comprises:
an electrode bridge extending in the second direction and connecting one rib and another rib adjacent to each other among the plurality of ribs; and
an electrode terminal extending from the electrode bridge in the third direction.

13. The battery assembly of claim 12, wherein the cap plate further comprises:
a terminal hole through which the electrode terminal passes; and
a terminal groove surrounding the terminal hole, and
wherein the cap plate assembly further comprises:
a second insulating plate disposed in the terminal groove; and
a terminal plate disposed on the second insulating plate in the terminal groove.

14. The battery assembly of claim 13, wherein the cap plate assembly further comprises a third insulating plate configured to be coated on an upper surface of the cap plate excluding the plurality of grooves, a side surface of the cap plate, and an upper surface of the terminal plate.

15. The battery assembly of claim 14, wherein the third insulating plate is disposed between the casing and the cap plate.

16. A method for manufacturing a battery assembly, the method comprising:
cutting a first electrode tab extending in a first direction of a first electrode assembly in a second direction intersecting the first direction to form a first-first electrode tab and a first-second electrode tab;
cutting a second electrode tab extending in the first direction of a second electrode assembly in the second direction to form a second-first electrode tab and a second-second electrode tab;
bending the first-first electrode tab and the second-first electrode tab in the second direction;
bending the first-second electrode tab and the second-second electrode tab in a direction opposite to the second direction;
accommodating the first electrode assembly and the second electrode assembly in a casing;
contacting the other surface of a cap plate with the first-first electrode tab, the first-second electrode tab, the second-first electrode tab, and the second-second electrode tab such that a plurality of grooves formed on one surface of the cap plate face an outer side; and
performing a primary welding of the first electrode tab and the second electrode tab to the cap plate by heating the plurality of grooves.

17. The method of claim 16, wherein the primary welding comprises irradiating a laser beam linearly onto the plurality of grooves.

18. The method of claim 16, wherein the primary welding comprises:
forming a first weld portion electrically connecting one of the plurality of grooves, one rib overlapping the one groove in a third direction intersecting the first direction and the second direction, and the first-second electrode tab to each other;
forming a second weld portion electrically connecting another one of the plurality of grooves, another rib overlapping the another groove in the third direction, the first-first electrode tab, and the second-second electrode tab to each other; and
forming a third weld portion electrically connecting yet another one of the plurality of grooves, yet another rib overlapping the yet another groove in the third direction, and the second-first electrode tab to each other.

19. The method of claim 16, further comprising, after the primary welding, performing a secondary welding of a contact surface where the casing and the cap plate abut each other.

20. The method of claim 19, wherein the secondary welding comprises irradiating a laser beam linearly onto the contact surface.
